(19) United States
(12) Patent Application Publication
(10) Pub. No.: US 2003/0066929 A1
(43) Pub. Date: Apr. 10, 2003

(54) Aircraft anti-hijacking system

(76) Inventors: Gail Valencia, Wellington, FL (US); Herbert M. Valencia, Wellington, FL (US)

Correspondence Address: Robert E. Pershes, Esq., Becker & Poliakoff, P.A., 3111 Stirling Road, Fort Lauderdale, FL, 33312, US

(21) Appl. No.: 10/081,676

(22) Filed: Feb. 22, 2002

Related U.S. Application Data
(60) Provisional application No. 60/327,795, filed on Oct. 10, 2001.

(51) Int. Cl. B64D 11/00; B64D 13/00

(52) U.S. Cl. 244/118.5

(57) ABSTRACT

This invention allows aircraft manufacturers, operators, and operators of other modes of transportation the ability to deny control of the conveyance to anyone attempting to hijack or otherwise intervene with operation of transport vehicles or facilities.

This application is a Continuation-in-Part of provisional application No. 60/327,795 filed Oct. 10, 2001.

### TECHNICAL FIELD

This Aircraft Anti-hijacking system allows aircraft operators worldwide the ability to prevent anyone from taking control of an aircraft or other modes of transportation by rendering all occupants, other than the pilots or operating crews, incapacitated.

### BACKGROUND ART

The present invention combines two well-established, but previously never combined, fields of art.

The first field is the Heating, Ventilation and Air-Conditioning (“HVAC”) systems of airlplanes. Airline HVAC systems are well established in the industry. The standard HVAC system on airplanes is comprised of two or more air cycle machines called “Packs.” These packs condition or super cool the hot air that comes from the engines. After the hot air is conditioned, it travels through ducts in the body of the aircraft. Normally, via separate vents to the passenger cabin and cockpit. Each vent includes a hot air “trim” valve that connects to the original hot air. This hot air trim valve can be adjusted to allow the proper mix of hot and conditioned air to provide the entire aircraft cabin with comfortable temperatures. The 2 Pack HVAC system described is used as the base model to assist in describing this invention. However, it is to be understood that smaller and larger airplanes may have a slightly different configuration than described. The current invention can be adjusted to work with any airplane's HVAC system.

The second field of art involves the methods used to sedate patients. The field of anesthesiology involves the study of drugs that allow doctors and nurses to perform surgery on patients. Any of the drugs that anesthesiologists utilize can be included as the incapacitating agent of the present invention. Preferably the incapacitating agent will be one with minimal side effects and low mortality rates.

### DISCLOSURE OF THE INVENTION

On Sep. 11, 2001, the United States was awaken from complacency when seemingly normal men confiscated four airplanes and used them as missiles of mass-destruction. Prior to this event, it was believed that if one were hijacked and did as the hijacker wished, one's life would be spared. Since this event, many precautions have been implemented to make flying safer. No one objects to body searches at security in airports. People leave two to three hours early to provide enough time to make it through security in time for their flight. Carry on luggage is thoroughly screened. The present invention provides a method to defeat any future hijack attempts. Furthermore, the present invention allows the airline industry to assure customers that it is now impossible to hijack an airplane and use it as a missile of mass-destruction.

### BRIEF DESCRIPTION OF THE DRAWINGS

FIG. 1 is the preferred embodiment of this invention and shows the typical aircraft heating, ventilation and air conditioning system (HVAC) with the addition of the present invention.

FIG. 2 is the enlarged detail from FIG. 1 of the preferred embodiment of this invention.

FIG. 3 is another embodiment of this invention wherein a separate ventilation system is provided.

FIG. 4 is an enlarged detail from FIG. 3 of another embodiment of this invention.

FIG. 5 shows the addition of a computer to monitor the altitude of the airplane, combining several elements of the present invention.

### MODES FOR CARRYING OUT THE INVENTION

This invention contains several methods of accomplishing its objectives.

An aircraft can be hijacked in three locations; on the ground, at cruising altitude, or somewhere in between. Cruising altitude is understood in the industry to be dependent upon stage length. The longer the stage length, the higher the cruising altitude. The higher the altitude, the lower the oxygen quantity and pressure available.

During flight, the airplane cabin is made comfortable and maintained at a lower altitude due to pressurization. On the ground, no pressurization is required. As the airplane climbs or descends, the HVAC system stabilizes the temperature in the cabin. The pressurization system controls the pressure in the aircraft, increasing oxygen pressure thereby preventing the occupants from passing out and allowing the occupants to be more comfortable and cognizant than they would be at the airplane's actual altitude.

A quick method that the airline industry can utilize to incapacitate anyone in the passenger cabin at cruising altitude would be to “dump” the pressurized air inside the cabin through a “Rapid Decompression” so that the air pressure in the cabin rapidly becomes equivalent to the air pressure outside the cabin. This is equivalent to punching out one of the airplane's windows or a hole in the side of the aircraft due to an explosion. The rapid decrease in pressure will reduce oxygen flow and pressure to an individual's lungs and cause the occupants to pass out. As the plane descends, the oxygen pressure will return to normal and the occupants in the cabin will awaken. Therefore, although this method is readily available for the industry, it is not the preferred embodiment of this invention.

A second, and more preferred method that the airline industry can utilize to incapacitate the occupants of the passenger cabin at any altitude or phase of flight would be to add the ability to introduce one or more incapacitating agents to the passenger cabin. Emergency buttons located in the cockpit and in the crew areas of the passenger cabin would activate the discharge of the incapacitating agents. The incapacitating agents would instantly render all the occupants of the passenger cabin unconscious and thereby prevent any hijack attempt.

The incapacitating agents could be xenon, nitrous oxide, diethyl ether, chloroform, fluroxene, halothane, desflurane, enflurane, isoflurane, methoxyflurane, sevoflurance, to name a few. The choice and combination of incapacitating agents will depend on which agent or agents provide the best anesthetic effects with the least side effects. For example, nitrous oxide has no effect on blood pressure or respiration, but it requires large quantities to achieve anesthetic effects. Halothane only requires a small quantity to achieve an anesthetic effect, but it has moderate analgesic and blood pressure effects and a large respiratory effect. The airline industry, and their insurance carriers, will best be able to determine which anesthetic or combination of anesthetics they would like to use. It is recognized that administering the incapacitating agent through the HVAC system of an airplane may result in the death of a few people. However, the death of a few people is better than the death of all the occupants of an airplane and much better than the use of the hijacked airplane as a weapon of destruction to kill thousands of people.

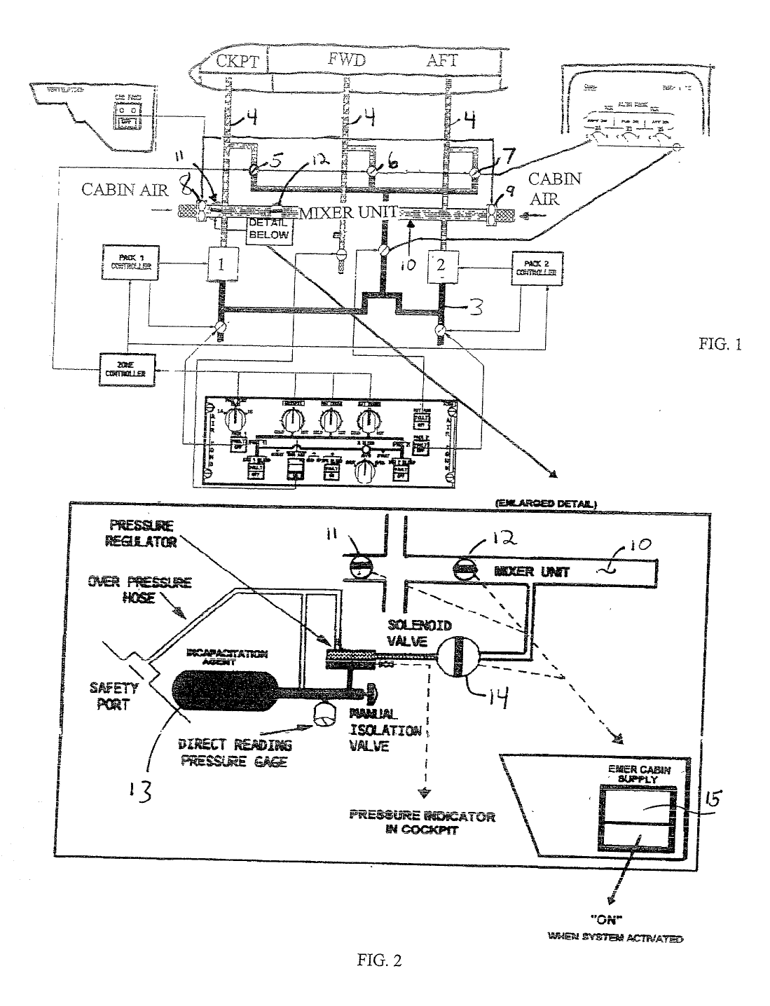

With reference to FIG. 1, a conventional 2 pack HVAC system for airplanes is shown with the addition of one embodiment of this invention. It is to be understood that smaller and larger airplanes may have a slightly different HVAC configuration than described. The current invention can be adjusted to work with any airplane's HVAC system.

The black ventilation pipes 3 depict warm air that comes from the engine. The warm air passes through, in this system, two conditioning systems, 1 and 2. The conditioned air proceeds into the cabin, as indicated by the gray dotted pipes 4. The temperature of the cockpit and passenger cabin can be adjusted through manipulation of valves 5, 6, 7, which allow the addition of warm air to the conditioned air. Finally, the cockpit and passenger cabin air are recirculated through filters, 8 and 9, into the mixer unit, 10, where it combines with the conditioned air of systems 1 and 2.

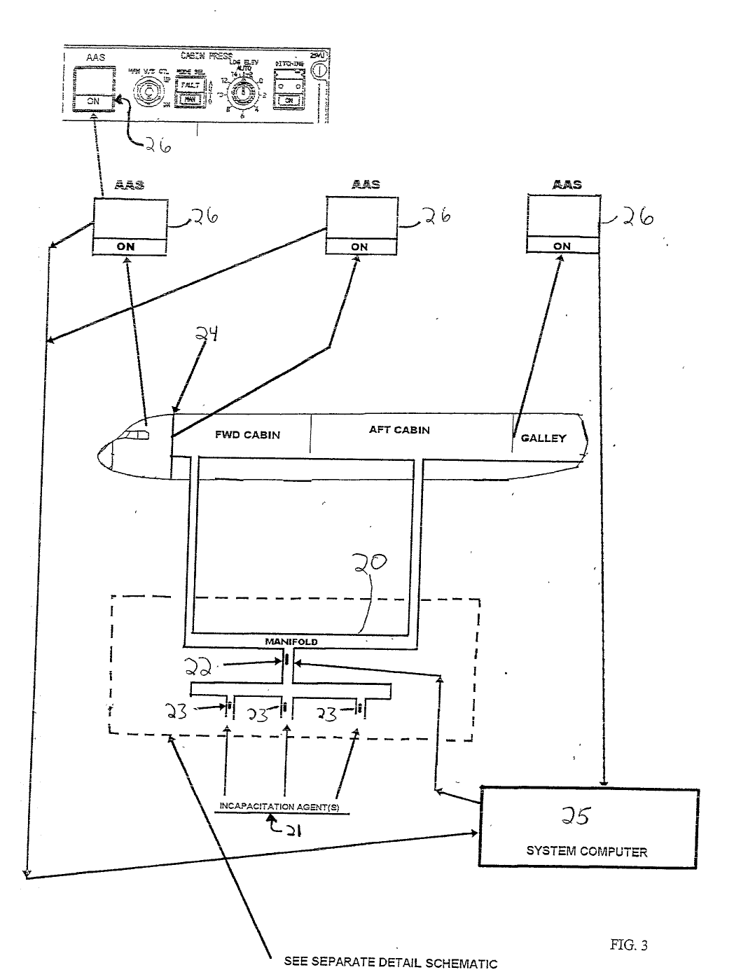

One embodiment of this invention, as shown in FIGS. 1 & 2, envisions the addition of two valves, 11 and 12, to the mixer unit, 10. Valve 11 is located between the cockpit air supply line and the return air duct, adjacent to filter 8. Valve 12 is located between the cockpit air supply line and the mixer unit 10. Normally, these valves, 11 and 12, will be open and the ventilation system will operate normally for the cockpit and passenger cabin areas. In an emergency situation, activation of an emergency button 15 in the cockpit or passenger cabin causes valves 11 and 12 to close, separating the ventilation system for the cockpit from the ventilation system for the passenger cabin. As is evident from FIG. 1, the cockpit will solely be supplied with fresh air from conditioning system 1. FIG. 2 also shows the incapacitation agent 13, which is attached to a solenoid valve 14. When the emergency button 15 in the cockpit or passenger cabin is pressed, this solenoid valve 14 opens to allow release of the incapacitation agent into the mixer unit 10 for distribution through the passenger cabin. In addition, the emergency buttons 15 in the cockpit and passenger cabin may be lit to indicate when the Aircraft Anti-Hijack System is activated.

The inventors believe that the present invention will not render the pilots unconscious for several reasons. Since Sep. 11, 2001, many airplanes have been retrofitted with security doors between the cockpit and the passenger cabin. These doors are extremely thick, to prevent hijackers from shooting their way into the cockpit. As part of this invention, an airtight bulkhead and door between the cockpit and the passenger cabin would be incorporated to prevent the incapacitating agents from entering the cockpit area. Additionally, as part of the Incapacitating System, the pilots would immediately don their oxygen masks to insure a safe breathing source free from the incapacitating agents. These masks are located in readily accessible positions around the cockpit allowing the pilots and the jumpseat riders to use them in case of rapid decompression, fire or other emergencies, as required for all high flying, pressurized passenger aircraft. By separating the cockpit from the passenger cabin air supply, and by providing the cockpit occupants with a separate and safe breathing source, the pilots can safely land the aircraft at the nearest suitable airport where the authorities can subdue any and all potential hijackers.

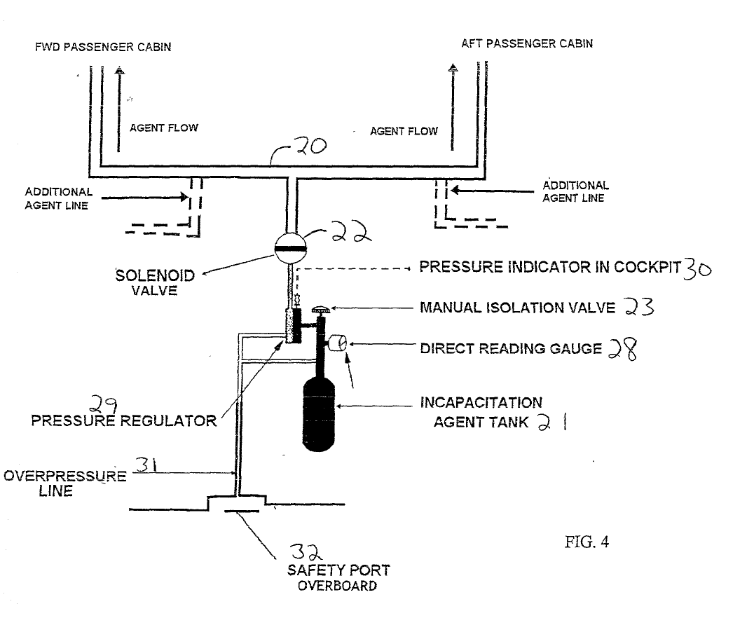

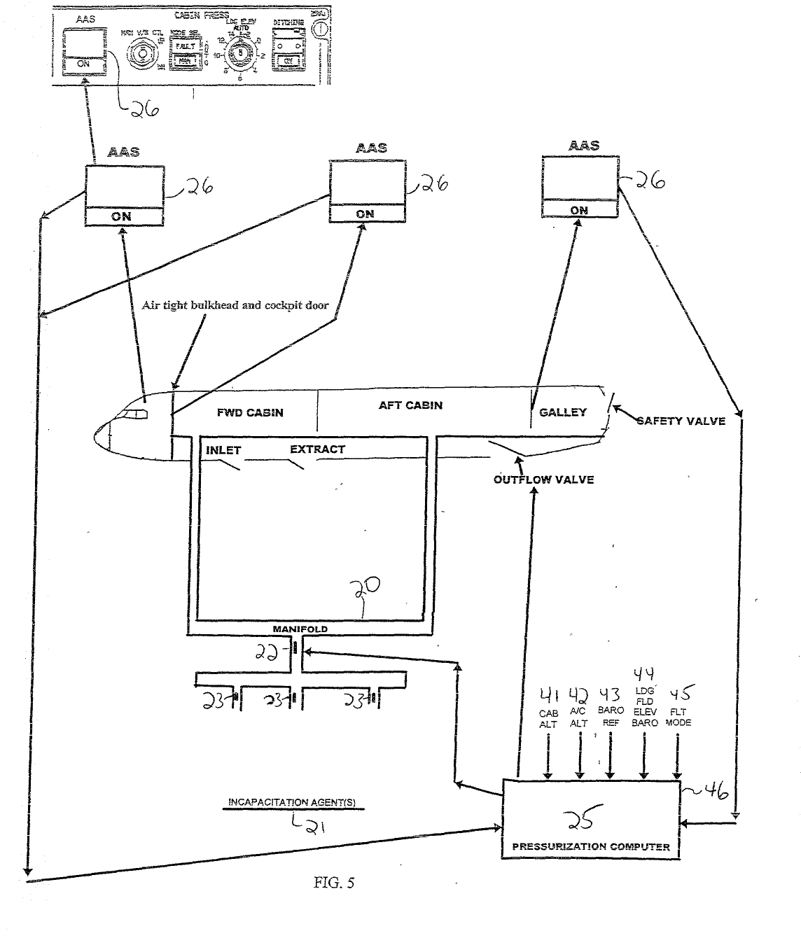

A second embodiment of this invention is shown in FIGS. 3 & 4. This embodiment teaches the addition of an independent incapacitation ventilation system to the passenger cabin. This system adds a separate ventilation manifold 20 containing direct access to the incapacitation agent 21. In this system, the valves 22 to the incapacitation agent 21 will be closed during routine flights. In an emergency situation, activation of the emergency button 26 in the cockpit or the flight crews areas of the passenger cabin will activate the Aircraft Anti-Hijacking System computer 25, which opens the valves 22 to the incapacitation agents 21 and renders all of the occupants of the passenger cabin unconscious. As depicted in FIG. 4, the system can utilize one container of incapacitation agent 21, or more depending on the size of the passenger cabin and the quantity of agent required to be effective. For installation, maintenance, and other reasons, each incapacitation agent 21 is separated by a manual isolation valves 23. Preferably, this system will utilize an airtight cockpit door and bulkhead 24. FIG. 3 provides better indication of the location of the Emergency Buttons 26 throughout the aircraft, in the cockpit and the crew areas of the passenger cabin. This configuration also shows normal safety features associated with pressurized gases, such as a direct read gauge 28, an isolation valve 23, a pressure indicator 30, pressure regulator 29, overpressure line 31 and safety port 32.

A third embodiment of the present invention combines the rapid decompression method with the incapacitation agent method. FIG. 5 teaches the addition of other functions to the computer system 25 utilized in FIG. 3. This computer system 25 monitors the airplane's altitude 41, the altitude to which the pressurization pack system has rendered the passenger cabin 42, the barometer reference 43, the landing field elevation barometer 44, the flight mode 45 and other variables 46 that might be utilized. When the airplane's altitude 41 is 35,000 feet or above, and the emergency button 26 is pressed, the computer automatically dumps the air pressure in the passenger cabin, bringing the cabin altitude up to the current aircraft altitude and instantly rendering the occupants unconscious. As the pilot starts the “Emergency Descent” to land the plane, the airplane's altitude decreases and upon reaching lower altitudes, the occupants have the potential to regain consciousness. Using a mathematical or algorithmic formula, based on known relationships between oxygen pressure and altitude, the computer system 25 determines when and how long to open the outflow valves and the proper altitude at which the incapacitating agents are introduced into the passenger cabin to keep the occupants unconscious until the aircraft lands.

To explain some potential other variables 46 that might be included in the computer system 25, an airplane manufacture may want to incorporate a sensor in the airtight cockpit door 24. If, during a long, overnight flight, a person attempts to break into the cockpit because the occupants of the passenger cabin, including the crew, are all sleeping, this sensor will tell the computer that someone is trying to enter the cockpit during flight. The Aircraft Anti-Hijacking System will automatically activate and render the occupants, including the perpetrator, unconscious.

Another variable 46 that may be included in the computer system 25 is a shock sensor. If, for some reason, a bomb explodes anywhere in the plane, but is not sufficient enough to destroy the complete airplane, the shock sensor can activate the computer system 25 to render all occupants of the passenger cabin unconscious. Therefore, if anyone had been planning to cause the plane to crash if the bomb was not sufficient, they will be rendered unconscious until the plane reaches safety.

The variables described within this specification are not meant to limit the present invention. Other, as yet unforeseen mechanisms, gases or variables may become important that may be incorporated into this Aircraft Anti-Hijacking System.

### INDUSTRIAL APPLICABILITY

The present invention provides a much-needed solution to the present danger that hijacked planes present. By simple and inexpensive means, the airline industry can provide greater security to the travelling public.

We claim:

1. An improvement to current HVAC systems in airplanes, the improvement comprising
the addition of a first valve to the mixer unit, said first valve being located to the left of the cockpit air supply line;
the addition of a second valve to the mixer unit, said second valve being located to the right of the cockpit air supply line; and
the addition of a conduit to the mixer unit, said conduit containing a third valve to a container containing incapacitation agent or a mixture of incapacitation agents.

2. The improvement of claim 1, wherein the three valves are activated by emergency buttons located in the cockpit and in the passenger cabin.

3. The improvement of claim 2, wherein activation of said three valves causes said first valve and said second valve to seal off the ventilation system for the cockpit from the ventilation system for the passenger cabin and said third valve to release an incapacitating agent into the ventilation system for the passenger cabin.

4. The improvement of claim 1, wherein the container containing incapacitation agent is under pressure.

5. The improvement of claim 1, further comprising the addition of an airtight cockpit door.

6. An addition to current and future airplanes, the addition comprising:
a separate and closed ventilation system with vents directly on the passenger cabin of the airplane,
said separate and closed ventilation system containing one or more incapacitation agents;
wherein said separate and closed ventilation system is activated by emergency buttons located in the cockpit and the passenger cabin.

7. The addition of claim 6, wherein the separate and closed ventilation system is added to the passenger cabin of an airplane.

8. The addition of claim 6, further comprising the addition of an airtight bulkhead and cockpit door.

9. A method of preventing hijacking, the method comprising
a. noting suspicious activity in the body of an airplane
b. hitting an emergency button that activates valves that
c. results in incapacitation of the occupants of the cabin, but not the cockpit,
d. landing the plane at the next suitable airport.

10. The method of claim 9, wherein the cockpit is separated from the cabin by an airtight bulkhead and cockpit door.

11. The method of claim 9, wherein the airplane is flying at cruising altitude and the valves dump all of the pressurized air in the cabin, resulting in a rapid decompression and reduction of air and oxygen pressure in the cabin that renders the occupants unconscious.

12. The method of claim 9, wherein the valves dump an incapacitating agent or a mixture of incapacitating agents into the passenger cabin, rendering all the occupants unconscious.

13. The method of claim 9, wherein two or more valves separate the ventilation system to the cockpit from the ventilation system for the passenger cabin and a third or more valves open to release an incapacitating agent into the passenger cabin, rendering unconscious all occupants of the passenger cabin.

14. The method of claim 9, wherein the suspicious activity is noted by occupants of the passenger cabin.

15. The method of claim 9, wherein the suspicious activity is noted by a computer system.
